(19) United States
(12) Patent Application Publication
(10) Pub. No.: US 2019/0068350 A1
(43) Pub. Date: Feb. 28, 2019

(54) RESOURCE UNIT SCHEDULING IN A WIRELESS NETWORK

(71) Applicant: QUALCOMM Incorporated, San Diego, CA (US)

(72) Inventors: Dustin Andrew Brown, San Diego, CA (US); Rajeev Kumar, San Diego, CA (US); Houston Hoffman, San Diego, CA (US)

(21) Appl. No.: 15/684,646

(22) Filed: Aug. 23, 2017

(51) Int. Cl. H04L 5/00; H04W 72/04

(52) U.S. Cl. CPC H04L 5/0094; H04L 5/0005; H04W 84/12; H04L 5/0087; H04W 72/0486; H04L 5/0037

(57) ABSTRACT

This disclosure provides systems, methods and apparatuses for allocating resource units (RUs) to stations (STAs) in a wireless network based at least in part on the type of data packet protocol employed by each of the STAs. In some implementations, smaller RUs are allocated more frequently to STAs that transmit or receive User Datagram Protocol (UDP) data packets than to STAs that transmit or receive Transmission Control Protocol (TCP) data packets. In some aspects, a wireless device may allocate relatively small RUs on a relatively frequent basis to STAs associated with UDP data transmissions, and may allocate relatively large RUs on a relatively infrequent basis to STAs associated with TCP data.

### TECHNICAL FIELD

This disclosure relates generally to wireless networks, and specifically to scheduling allocations of resource units for wireless communications.

### DESCRIPTION OF THE RELATED TECHNOLOGY

A wireless local area network (WLAN) may be formed by one or more access points (APs) that provide a shared wireless medium for use by a number of client devices. Each AP, which may correspond to a Basic Service Set (BSS), periodically broadcasts beacon frames to enable compatible client devices within wireless range of the AP to establish and maintain a communication link with the WLAN. WLANs that operate in accordance with the IEEE 802.11 family of standards are commonly referred to as Wi-Fi networks, and client devices that communicate with the AP in a Wi-Fi network may be referred to as wireless stations (STAs).

In older or “legacy” Wi-Fi networks, wireless devices (such as APs and STAs) typically compete with each other for access to the shared wireless medium. For example, wireless devices may use carrier sense multiple access with collision avoidance (CSMA/CA) techniques to “listen” to the wireless medium to determine when the wireless medium is idle. When the wireless medium has been idle for a given duration, the wireless devices may contend for medium access by waiting a random “back-off” period before attempting to transmit on the wireless medium. The wireless device having the shortest back-off period wins the contention operation, and may be granted exclusive access to the shared wireless medium for a period of time commonly referred to as a transmit opportunity (TXOP).

Recent revisions to the IEEE 802.11 specification introduce multiple channel access mechanisms that allow multiple STAs to transmit and receive data on a shared wireless medium at the same time. For example, the frequency spectrum of a wireless network may be divided into a plurality of unique resource units (RUs) each including a number of different frequency subcarriers. A trigger frame may be used to allocate a number of unique RUs to a plurality of STAs for a given time period. Each of the plurality of STAs may transmit or receive data during the given time period using the unique RU(s) allocated by the trigger frame. In this manner, multiple STAs may transmit or receive data at the same time without contending for medium access.

### SUMMARY

The systems, methods and devices of this disclosure each have several innovative aspects, no single one of which is solely responsible for the desirable attributes disclosed herein.

One innovative aspect of the subject matter described in this disclosure may be implemented as a method for allocating medium resources to a plurality of stations (STAs) in a wireless network. The method may include determining a type of data packet protocol employed by each of the plurality of STAs for transmitting or receiving data packets, allocating a number of resource units (RUs) to one or more of the STAs based at least in part on the determined types of data packet protocols, and transmitting a trigger frame indicating the allocation of the number of RUs to the one or more STAs. The method may include identifying a first number of the STAs that employ a user datagram protocol (UDP) for transmitting or receiving data packets, identifying a second number of the STAs that employ a transmission control protocol (TCP) for transmitting or receiving data packets, and allocating smaller RUs more frequently to the first number of STAs than to the second number of STAs. In some aspects, the method may allocate relatively small RUs on a relatively frequent basis to the first number of STAs, and may allocate relatively large RUs on a relatively infrequent basis to the second number of STAs.

In some implementations, a level of traffic on the wireless network may be determined, and the allocation of RUs to the one or more STAs may also be based on the determined level of traffic. In addition, or in the alternative, an amount of aggregated data units exchanged with each of the STAs may be determined, and the allocation of RUs to the one or more STAs may also be based on the determined amounts of aggregated data units.

Another innovative aspect of the subject matter described in this disclosure may be implemented in a wireless device including one or more processors and a memory configured to store instructions. Execution of the instructions by the one or more processors may cause the wireless device to determine a type of data packet protocol employed by each of a plurality of STAs for transmitting or receiving data packets, to allocate a number of resource units (RUs) to one or more of the STAs based at least in part on the determined types of data packet protocols, and to transmit a trigger frame indicating the allocation of the number of RUs to the one or more STAs.

Another innovative aspect of the subject matter described in this disclosure may be implemented in a non-transitory computer-readable medium. The non-transitory computer-readable medium may comprise instructions that, when executed by one or more processors of a wireless device, cause the wireless device to perform a number of operations. The number of operations may include determining a type of data packet protocol employed by each of a plurality of STAs for transmitting or receiving data packets, allocating a number of resource units (RUs) to one or more of the STAs based at least in part on the determined types of data packet protocols, and transmitting a trigger frame indicating the allocation of the number of RUs to the one or more STAs.

Another innovative aspect of the subject matter described in this disclosure may be implemented in a wireless device. The wireless device may include means for determining a type of data packet protocol employed by each of a plurality of STAs for transmitting or receiving data packets, means for allocating a number of resource units (RUs) to one or more of the STAs based at least in part on the determined types of data packet protocols, and means for transmitting a trigger frame indicating the allocation of the number of RUs to the one or more STAs.

### BRIEF DESCRIPTION OF THE DRAWINGS

FIG. 1 shows a block diagram of an example wireless system.

FIG. 2 shows a block diagram of an example wireless device.

FIGS. 3A-3C show example subcarrier allocations and resource unit distributions within different channel bandwidths.

FIG. 4A shows a timing diagram depicting an example operation using trigger frames to allocate resource units (RUs) to one or more wireless stations.

FIG. 4B shows a timing diagram depicting another example operation using trigger frames to allocate resource units (RUs) to one or more wireless stations.

FIG. 5A shows an illustration depicting an example allocation of resource units based on a type of data packet protocol used by the wireless devices.

FIG. 5B shows an illustration depicting an example allocation of resource units based on amounts of aggregated data units transmitted by the wireless devices.

FIG. 6A shows an illustrative flow chart depicting an example operation for allocating wireless medium resources to wireless devices.

FIG. 6B shows an illustrative flow chart depicting an example operation for determining a type of data packet protocol employed by each of a plurality of STAs.

FIG. 6C shows an illustrative flow chart depicting an example operation for allocating a number of RUs to one or more stations.

FIG. 7A shows an illustrative flow chart depicting another example operation for allocating wireless medium resources to wireless devices.

FIG. 7B shows an illustrative flow chart depicting an example operation for allocating a number of RUs to one or more stations.

FIG. 8 shows an example trigger frame.

FIG. 9A shows an example Common Info field of a trigger frame.

FIG. 9B shows an example Per User Info field of a trigger frame.

Like reference numbers and designations in the various drawings indicate like elements.

### DETAILED DESCRIPTION

The following description is directed to certain implementations for the purposes of describing the innovative aspects of this disclosure. However, a person having ordinary skill in the art will readily recognize that the teachings herein can be applied in a multitude of different ways. The described implementations may be implemented in any device, system or network that is capable of transmitting and receiving RF signals according to any of the IEEE 802.11 specifications, or any of the IEEE 802.15 specifications, the Bluetooth® standard, code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1×EV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless, cellular or internet of things (IOT) network, such as a system utilizing 3G, 4G or 5G, or further implementations thereof, technology.

Implementations of the subject matter described in this disclosure may be used to reduce latencies resulting from network traffic by allocating resource units (RUs) to one or more stations (STAs) in a wireless network based on a number of parameters including at least one of a type of data packet protocol used by each of the STAs, the amount of aggregated data units transmitted or received by each of the STAs, a level of traffic on the wireless network, or any combination thereof. The type of data packet protocol used by each of the STAs and the amount of aggregated data units transmitted or received by each of the STAs may be determined from previous data transmissions or receptions associated with each of the STAs, for example, in one or more previous or current transmit opportunities (TXOPs). In this manner, the protocol type and the amount of aggregated data units that may be transmitted by each of the STAs in one or more subsequent TXOPs may be predicted based on previous data transmissions or receptions of each of the STAs. In some implementations, the number, the size, and/or the periodicity of RUs allocated to the STAs may be determined or adjusted based on the determined types of data packet protocols employed by the STAs, the amounts of aggregated data units transmitted or received by the STAs, or both.

In some implementations, RUs may be allocated to the STAs based on a type of data packet protocol used by each of the STAs for transmitting or receiving data packets. The protocol types may include, for example, a User Datagram Protocol (UDP) and a Transmission Control Protocol (TCP). UDP data packets may be associated with time critical applications having relatively low error tolerances (such as voice and video transmissions), while TCP data packets may be associated with non-time critical applications having relatively high error tolerances (such as data back-up operations). In some aspects, RUs of relatively small sizes may be allocated relatively frequently to STAs that transmit or receive UDP data packets, and RUs of relatively large sizes may be allocated relatively infrequently to STAs that transmit or receive TCP data packets. In other words, the RUs allocated to STAs that transmit or receive UDP data packets may be of smaller sizes than the RUs allocated to STAs that transmit or receive TCP data packets, and may be allocated more frequently to STAs that transmit or receive UDP data packets than to STAs that transmit or receive TCP data packets. Allocating RUs more frequently to STAs that transmit or receive UDP data packets than to STAs that transmit or receive TCP data packets may ensure that a sufficient amount of wireless network resources is (and will be) available to accommodate UDP data transmissions, for example, so that time critical applications associated with UDP data transmissions do not incur undesirable latencies resulting from an unavailability of RUs upon which to transmit UDP data packets. Allocating smaller RUs to STAs that transmit or receive UDP data packets than to STAs that transmit or receive TCP data packets may ensure that resources of the wireless network are fairly allocated between UDP data transmissions and TCP data transmissions, for example, because RUs are allocated more frequently to STAs that transmit or receive UDP data packets than to STAs that transmit or receive TCP data packets.

Additionally, or alternatively, in some implementations, RUs may be allocated to the STAs based on an amount of aggregated data units or packets transmitted to or received from each of the STAs. The amount of aggregated data units or packets associated with a respective STA may be based on the sizes or the numbers (or both) of aggregated data units or packets exchanged with the respective STA in a time period. The aggregated data units or packets may include, for example, aggregated MAC data protocol units (A-MPDUs) and aggregated MAC service data units (A-MSDUs). The use of A-MPDUs and A-MSDUs may reduce overhead associated with formatting, encoding, and transmitting a plurality of data packets individually by encapsulating the plurality of data frames or packets into a single aggregated data unit for transmission. In some aspects, a greater amount of RUs may be allocated to STAs that exchange relatively large amounts of aggregated data units than to STAs that exchange relatively small amounts of aggregated data units. In other aspects, RUs may be allocated more frequently to STAs that exchange relatively large amounts of aggregated data units than to STAs that exchange relatively small amounts of aggregated data units. In this manner, aspects of the present disclosure may not only encourage the use of A-MPDUs and A-MSDUs but may also ensure that enough bandwidth of the wireless network is available to accommodate the transmission of such aggregated data units.

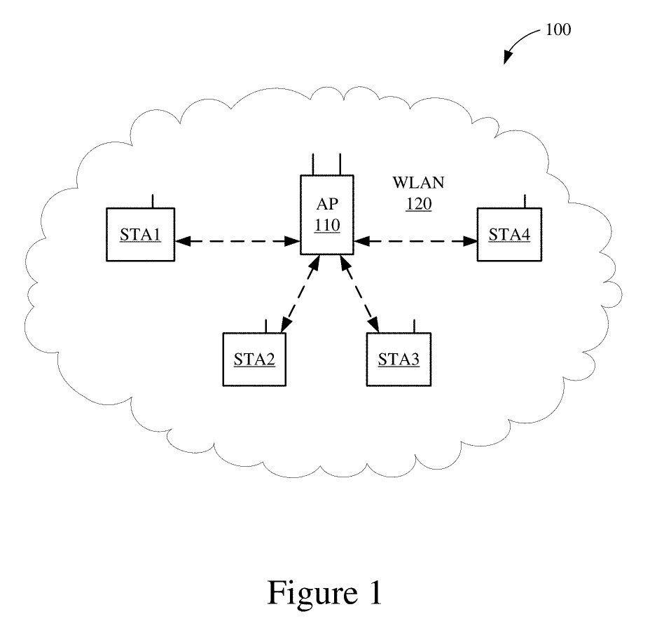

FIG. 1 shows a block diagram of an example wireless system 100. The wireless system 100 is shown to include four wireless stations STA1-STA4, a wireless access point (AP) 110, and a wireless local area network (WLAN) 120. The WLAN 120 may be formed by a plurality of access points (APs) that may operate according to the IEEE 802.11 family of specifications (or according to other suitable wireless protocols). Thus, although only one AP 110 is shown in FIG. 1 for simplicity, it is to be understood that WLAN 120 may be formed by any number of access points such as AP 110. The AP 110 may be assigned a unique MAC address that is programmed therein by, for example, the manufacturer of the access point. Similarly, each of the stations STA1-STA4 also may be assigned a unique MAC address. Although not specifically shown in FIG. 1, for at least some implementations, the stations STA1-STA4 may exchange signals directly with each other (such as without the presence of the AP 110).

In some implementations, the wireless system 100 may correspond to a multiple-input multiple-output (MIMO) wireless network, and may support single-user MIMO (SU-MIMO) and multi-user (MU-MIMO) communications. For other implementations, the wireless system 100 may correspond to or utilize orthogonal frequency division multiple access (OFDMA) communications. Further, although the WLAN 120 is depicted in FIG. 1 as an infrastructure Basic Service Set (BSS), for other implementations, WLAN 120 may be an Independent Basic Service Set (IBSS), an Extended Service Set (ESS), an ad-hoc network, or a peer-to-peer (P2P) network (such as operating according to Wi-Fi Direct protocols).

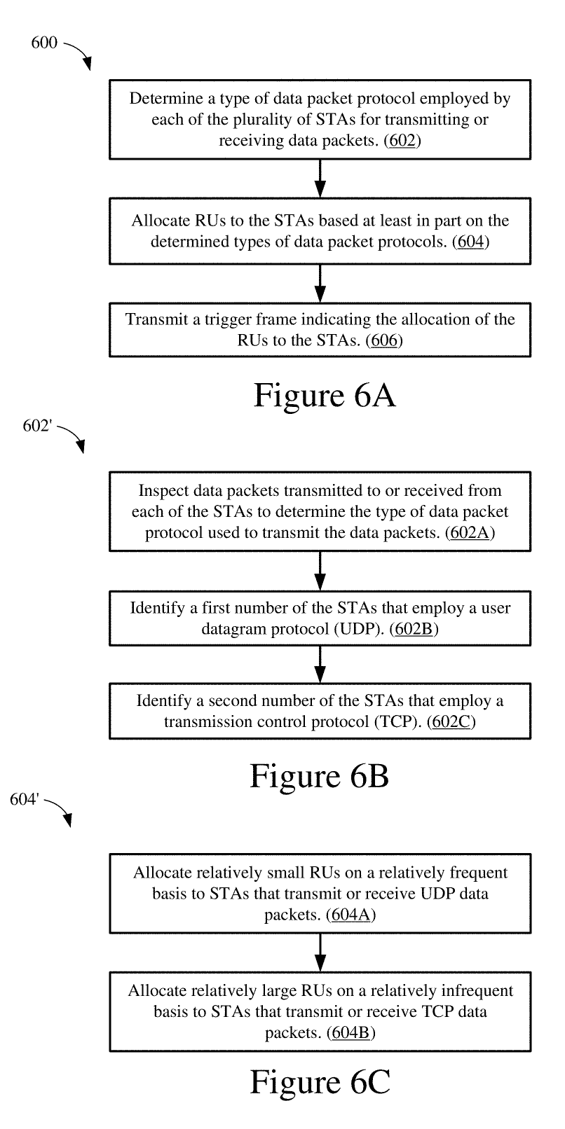

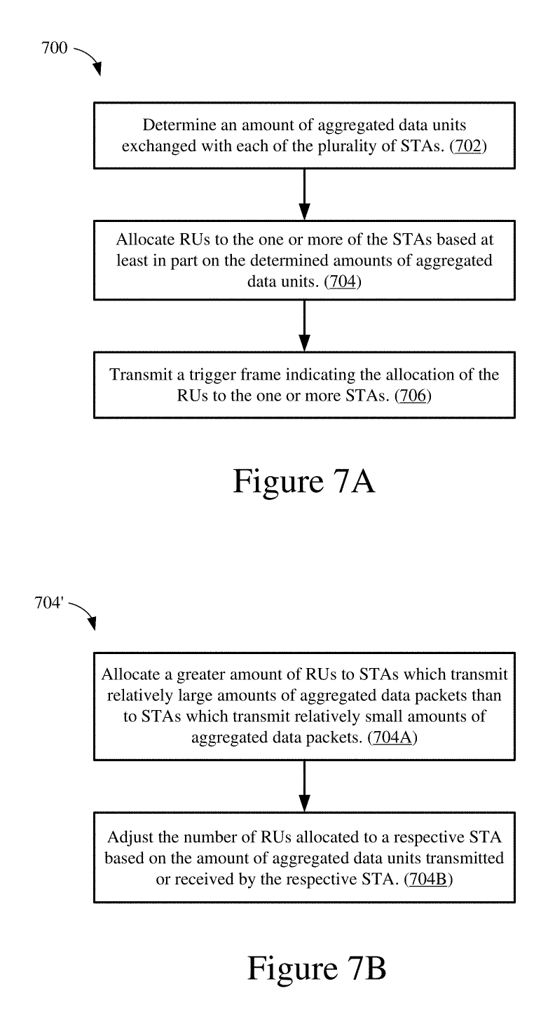

The stations STA1-STA4 may be any suitable Wi-Fi enabled wireless devices including, for example, cell phones, personal digital assistants (PDAs), tablet devices, laptop computers, or the like. The stations STA1-STA4 also may be referred to as a user equipment (UE), a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. For at least some implementations, each of stations STA1-STA4 may include a transceiver, one or more processing resources (such as processors or ASICs), one or more memory resources, and a power source (such as a battery). The memory resources may include a non-transitory computer-readable medium (such as one or more nonvolatile memory elements, such as EPROM, EEPROM, Flash memory, a hard drive, etc.) that stores instructions for performing operations described below with respect to FIGS. 6A-6C and FIGS. 7A-7B.

The AP 110 may be any suitable device that allows one or more wireless devices to connect to a network (such as a local area network (LAN), wide area network (WAN), metropolitan area network (MAN), or the Internet) via AP 110 using Wi-Fi, Bluetooth, cellular, or any other suitable wireless communication standards. For at least some implementations, AP 110 may include a transceiver, a network interface, one or more processing resources, and one or more memory sources. The memory resources may include a non-transitory computer-readable medium (such as one or more nonvolatile memory elements, such as EPROM, EEPROM, Flash memory, a hard drive, etc.) that stores instructions for performing operations described below with respect to FIGS. 6A-6C and FIGS. 7A-7B. In some implementations, one or more functions of an AP, such as AP 110, may be performed by a station, such as one of stations STA1-STA4 (for example, when the station is operating as a soft AP).

The one or more transceivers in each of the stations STA1-STA4 and the AP 110 may include Wi-Fi transceivers, Bluetooth transceivers, cellular transceivers, or other suitable radio frequency (RF) transceivers (not shown for simplicity) to transmit and receive wireless communication signals. Each transceiver may communicate with other wireless devices in distinct frequency bands or using distinct communication protocols. For example, the Wi-Fi transceiver may communicate within a 2.4 GHz frequency band, within a 5 GHz frequency band, or within a 60 GHz frequency band in accordance with the IEEE 802.11 family of specifications. The cellular transceiver may communicate within various RF frequency bands in accordance with the LTE protocol described by the 3rd Generation Partnership Project (3GPP) (such as between approximately 700 MHz and approximately 3.9 GHz) or in accordance with other cellular protocols (such as the GSM protocol). In some implementations, the transceivers included within the stations STA1-STA4 or the AP 110 may be any technically feasible transceiver such as a ZigBee transceiver described by a specification from the ZigBee Alliance, a WiGig transceiver, or a HomePlug transceiver described by a specification from the HomePlug Alliance.

In some implementations, the AP 110 may schedule or manage downlink (DL) and uplink (UL) communications associated with the WLAN 120. The AP 110 may selectively allocate unique portions (such as subcarriers) of the available bandwidth of the WLAN 120 to different stations STA1-STA4 so that multiple stations STA1-STA4 can concurrently transmit or receive data during the same transmit opportunity (TXOP). For one example, the AP 110 may schedule queued DL data to be concurrently transmitted to multiple STAs during a DL TXOP. For another example, the AP 110 may schedule or solicit multiple STAs to concurrently transmit UL data during a UL TXOP.

The IEEE 802.11ax specification defines a logical grouping or collection of subcarriers as a “resource unit” (RU) that may be allocated to a specific wireless device (or group of wireless devices) for UL or DL transmissions. In some implementations, the AP 110 may prioritize a number of wireless devices (such as the stations STA1-STA4) based on one or more parameters, and then allocate RUs to the wireless devices based at least in part on their respective priorities. The one or more parameters may include a type of data packet protocol used by a wireless device, an amount (for example, in terms of number or size) of aggregated data units or packets transmitted from or received by the wireless device, a level of traffic on the wireless network, or any other suitable parameter or metric that may affect performance of the wireless device or the wireless network.

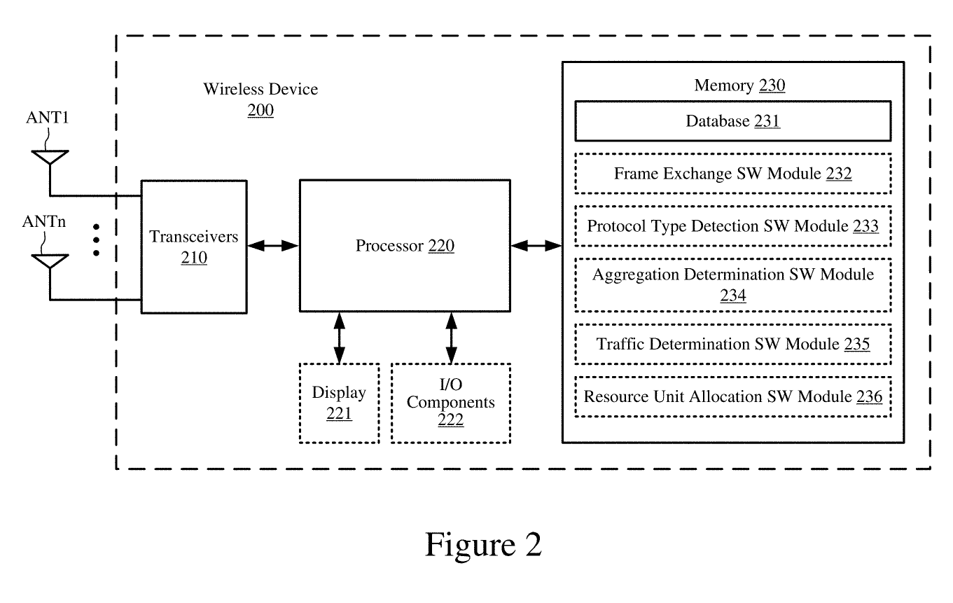

FIG. 2 shows a block diagram of an example wireless device 200. The example wireless device 200 may be one implementation of at least one of the stations STA1-STA4 or the AP 110 of FIG. 1. The wireless device 200 may include one or more transceivers 210, a processor 220, a memory 230, and a number of antennas ANT1-ANTn. The transceivers 210 may be coupled to antennas ANT1-ANTn, either directly or through an antenna selection circuit (not shown for simplicity). The transceivers 210 may be used to transmit signals to and receive signals from other wireless devices including, for example, the AP 110 or one or more of the stations STA1-STA4 of FIG. 1. Although not shown in FIG. 2 for simplicity, the transceivers 210 may include any number of transmit chains to process and transmit signals to other wireless devices via the antennas ANT1-ANTn, and may include any number of receive chains to process signals received from the antennas ANT1-ANTn. Thus, the wireless device 200 may be configured for MIMO operations. The MIMO operations may include SU-MIMO operations and MU-MIMO operations. In addition, the wireless device 200 may be configured for OFDMA communications and/or other suitable multiple access mechanisms, for example, as may be provided in the IEEE 802.11ax standards.

Further, in some aspects, the wireless device 200 may use multiple antennas ANT1-ANTn to provide antenna diversity. Antenna diversity may include polarization diversity, pattern diversity, and spatial diversity. For purposes of discussion herein, the processor 220 is shown as coupled between the transceivers 210 and the memory 230. For actual implementations, the transceivers 210, the processor 220, and the memory 230 may be connected together using one or more buses (not shown for simplicity).

In some implementations (such as when the wireless device 200 is a wireless station), the wireless device 200 may optionally include (or be coupled to) a display 221 and a user interface 222. The display 221 may be any suitable display or screen allowing for user interaction and/or to present items or data to a user. In some aspects, the display 221 may be a touch-sensitive display. The I/O components 222 may be or include any suitable mechanism, interface, or device to receive input (such as commands) from the user and to provide output to the user. For example, the I/O components 222 may include (but are not limited to) a graphical user interface, keyboard, mouse, microphone and speakers, and so on.

The memory 230 may include a database 231 that may store location data, configuration information, data rates, MAC addresses, timing information, modulation and coding schemes, channel information, received signal strength indicator (RSSI) values, goodput values, channel state information (CSI), supported data rates, and/or other suitable information about (or pertaining to) a number of access points, stations, and other wireless devices. The database 231 also may store a type of data packet protocol employed by each of a number of wireless stations during one or more time periods, an amount of aggregated data units transmitted or received by each of a number of wireless stations during one or more time periods, and levels of traffic on the wireless network during one or more time periods.

The memory 230 also may include a non-transitory computer-readable storage medium (such as one or more nonvolatile memory elements, such as EPROM, EEPROM, Flash memory, a hard drive, and so on) that may store the following software modules:
a frame exchange software module 232 to create and exchange frames (such as data frames, control frames, management frames, and trigger frames) between the wireless device 200 and other wireless devices, for example, as described below with respect to FIGS. 6A-6C and FIGS. 7A-7B;
a protocol type detection software module 233 to determine a type of data packet protocol (such as UDP or TCP) employed by each of a number of STAs in a wireless network for transmitting or receiving data packets, for example, as described below with respect to FIGS. 6A-6C and FIGS. 7A-7B;
an aggregation determination software module 234 to determine numbers, sizes or amounts of aggregated data units or packets (such as A-MPDUs and A-MSDUs) exchanged with each of the number of STAs in the wireless network, for example, as described below with respect to FIGS. 6A-6C and FIGS. 7A-7B;
a traffic determination software module 235 to determine levels of traffic on the wireless network, for example, as described below with respect to FIGS. 6A-6C and FIGS. 7A-7B; and
a resource unit allocation software module 236 to allocate RUs to one or more STAs in the wireless network based on the determined types of data packet protocols employed by the STAs, on the numbers, sizes or amounts of aggregated data units or packets exchanged with each of the STAs, or both, for example, as described below with respect to FIGS. 6A-6C and FIGS. 7A-7B.
   Each software module includes instructions that, when executed by the processor 220, may cause the wireless device 200 to perform the corresponding functions. The non-transitory computer-readable medium of the memory 230 thus includes instructions for performing all or a portion of the operations described below with respect to FIGS. 6A-6C and FIGS. 7A-7B.

The processor 220 may be any one or more suitable processors capable of executing scripts or instructions of one or more software programs stored in wireless device 200 (such as within the memory 230). The processor 220 may execute the frame exchange software module 232 to create and exchange frames (such as data frames, control frames, management frames, and trigger frames) between the wireless device 200 and other wireless devices. In some implementations, the processor 220 may execute the frame exchange software module 232 to generate and transmit a trigger frame that allocates a number of RUs to one or more STAs for uplink (UL) data transmissions, for downlink (DL) data transmissions, or both.

The processor 220 may execute the protocol type detection software module 233 to determine a type of data packet protocol (such as UDP or TCP) employed by each of the STAs in a wireless network for transmitting or receiving data packets. In some aspects, execution of the protocol type detection software module 233 may classify a respective STA as a UDP STA if the respective STA transmits and receives data according to the user datagram protocol (UDP), and may classify a respective STA as a TCP STA if the respective STA transmits and receives data according to the transmission control protocol (TCP).

The processor 220 may execute the aggregation determination software module 234 to determine the numbers, sizes or amounts of aggregated data units or packets (such as A-MPDUs and A-MSDUs) exchanged with each of the number of STAs in the wireless network. In some aspects, execution of the aggregation determination software module 234 may determine an average size of A-MPDUs and A-MSDUs transmitted to or received from each of the STAs during a time period. In other aspects, execution of the aggregation determination software module 234 may determine a median size of A-MPDUs and A-MSDUs transmitted to or received from each of the STAs during a time period. In other some aspects, execution of the aggregation determination software module 234 may determine the amount of aggregated data transmitted to or received from each of the STAs during the time period.

The processor 220 may execute the traffic determination software module 235 to determine network traffic conditions of the wireless network. In some aspects, execution of the traffic determination software module 235 may determine a level of traffic on the wireless network, which may be used to determine whether to postpone transmission of a trigger frame. For example, execution of the traffic determination software module 235 may indicate a high-traffic condition if the level of traffic is greater than a value, and may indicate a low-traffic condition if the level of traffic is not greater than the value. In other aspects, execution of the traffic determination software module 235 may determine a load on the wireless network, which may be used as a factor when allocating wireless medium resources to one or more STAs.

The processor 220 may execute the resource unit allocation software module 236 to allocate RUs to one or more of the STAs in the wireless network based on the determined types of data packet protocols employed by the STAs. In some implementations, execution of the resource unit allocation software module 236 may allocate RUs of smaller sizes on a more frequent basis to STAs that transmit or receive UDP data packets than to STAs that transmit or receive TCP data packets. In some aspects, the wireless device 200 may allocate relatively small RUs on a relatively frequent basis to STAs that transmit or receive UDP data packets, and may allocate relatively large RUs on a relatively infrequent basis to STAs that transmit or receive TCP data packets. In addition, or in the alternative, the wireless device 200 may allocate at least one RU to each of the STAs that transmit or receive UDP data packets during any given time period (such as a TXOP).

As used herein, a relatively small RU may refer to an RU having a size or number of frequency subcarriers that is less than an amount, and a relatively large RU may refer to an RU having a size or number of frequency subcarriers that is greater than or equal to the amount. For one example, a relatively small RU may refer to an RU that includes 26 frequency subcarriers, and a relatively large RU may refer to an RU that includes 52 frequency subcarriers. For another example, a relatively small RU may refer to an RU that is 2 MHz wide, and a relatively large RU may refer to an RU that is 4 MHz wide.

In some aspects, allocating RUs on a relatively frequent basis may refer to RU allocations that occur N milliseconds (ms), and allocating RUs on a relatively infrequent basis may refer to RU allocations that occur M ms, where N and M are integers, and the value of N is less than the value of M. For example, the wireless device 200 may allocate RUs to STAs that transmit or receive UDP data packets every N ms, and may allocate RUs to STAs that transmit or receive TCP data packets every M ms. In other aspects, allocating RUs on a relatively frequent basis may refer to allocating RUs to one or more STAs in every P^{th} trigger frame, and allocating RUs on a relatively infrequent basis may refer to allocating RUs to one or more STAs in every S^{th} trigger frame, where P and S are integers, and the value of S is less than the value of P. For example, the wireless device 200 may allocate RUs to STAs that transmit or receive UDP data packets in every trigger frame, and may allocate RUs to STAs that transmit or receive TCP data packets every other trigger frame (such that S=1 and P=2).

In addition, or in the alternative, execution of the resource unit allocation software module 236 may allocate wireless medium resources to one or more STAs based on the numbers, sizes or amounts of aggregated data units transmitted to or from the STAs. In some aspects, the wireless device 200 may allocate a greater amount of RUs to STAs that transmit relatively large amounts of aggregated data packets than to STAs that transmit relatively small amounts of aggregated data packets. In other aspects, the wireless device 200 may adjust the number or size of RUs allocated to a respective STA based on the amount of aggregated data units transmitted or received by the respective STA.

Although functionality is described above with respect to software modules, in some implementations, an equivalent functionality may be provided by hardware modules, firmware modules, or any feasible combination of hardware, firmware, and software modules (not shown for simplicity).

As mentioned above, the IEEE 802.11ax specification may introduce multiple access mechanisms, such as an orthogonal frequency-division multiple access (OFDMA) mechanism, to allow multiple STAs to transmit and receive data on a shared wireless medium at the same time. For a wireless network using OFDMA, the available frequency spectrum may be divided into a plurality of resource units (RUs) each including a number of different frequency subcarriers. Different RUs may be allocated or assigned to different wireless devices (such as STAs) at a given point in time. In this manner, multiple wireless devices may concurrently transmit data on the wireless medium using their assigned RUs (and their respective frequency subcarriers). Because each RU may include a subset of the available frequency subcarriers that is much smaller than the overall frequency spectrum of the wireless medium, the IEEE 802.11ax specification may allow wireless devices to transmit data to each other using smaller channel bandwidths of 2 MHz, 4 MHz, 8 MHz, and 16 MHz (such as compared to a primary 20 MHz channel and one or more secondary channels of varying bandwidths).

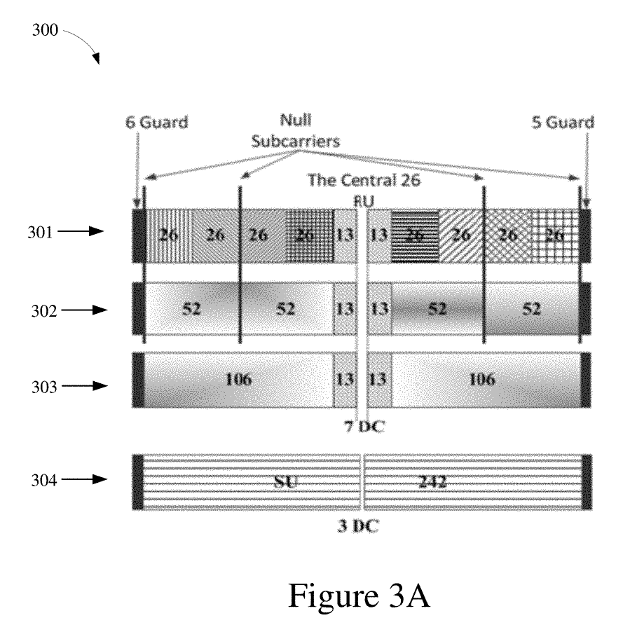

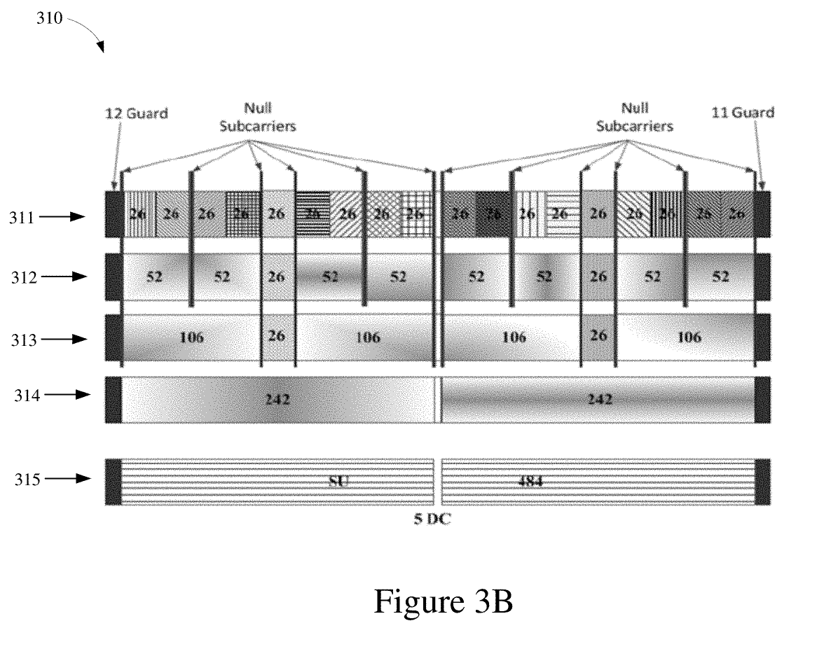

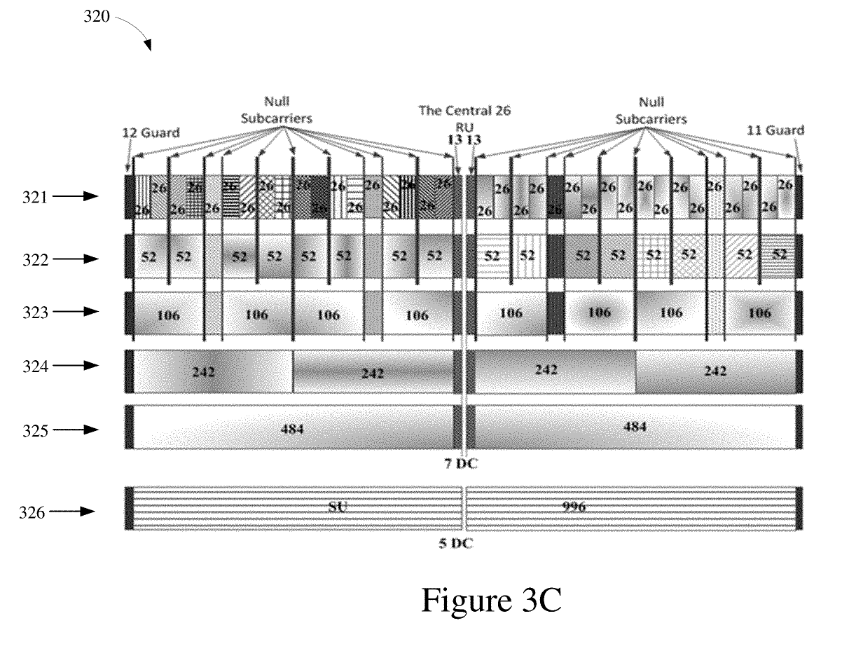

FIGS. 3A-3C show example subcarrier allocations and resource unit (RU) distributions within different channel bandwidths. FIG. 3A shows a subcarrier allocation diagram 300 for a 20 MHz bandwidth according to the draft IEEE 802.11ax specification. As shown in FIG. 3A, a 20 MHz bandwidth may be divided into a number of resource units (RUs), and each RU may include a number of subcarriers. For example, a first subcarrier allocation 301 may include a number of RUs each including 26 subcarriers, a second subcarrier allocation 302 may include a number of RUs each including 52 subcarriers, a third subcarrier allocation 303 may include a number of RUs each including 106 subcarriers, and a fourth subcarrier allocation 304 may include one RU including 242 subcarriers. For each of the example subcarrier allocations 301-304 depicted in FIG. 3A, adjacent RUs may be separated by a null subcarrier (such as a DC subcarrier), for example, to reduce leakage between adjacent RUs.

FIG. 3B shows a subcarrier allocation diagram 310 for a 40 MHz bandwidth according to the draft IEEE 802.11ax specification. As shown in FIG. 3B, a 40 MHz bandwidth may be divided into a number of RUs, and each RU may include a number of subcarriers. For example, a first subcarrier allocation 311 may include a number of RUs each including 26 subcarriers, a second subcarrier allocation 312 may include a number of RUs each including 52 subcarriers, a third subcarrier allocation 313 may include a number of RUs each including 106 subcarriers, a fourth subcarrier allocation 314 may include a number of RUs each including 242 subcarriers, and a fifth subcarrier allocation 315 may include one RU including 484 subcarriers. For each of the example subcarrier allocations 311-316 depicted in FIG. 3B, adjacent RUs may be separated by a null subcarrier, for example, to reduce leakage between adjacent RUs.

FIG. 3C shows a subcarrier allocation diagram 320 for an 80 MHz bandwidth according to the draft IEEE 802.11ax specification. As shown in FIG. 3C, an 80 MHz bandwidth may be divided into a number of resource units (RUs), and each RU may include a number of subcarriers. For example, a first subcarrier allocation 321 may include a number of RUs each including 26 subcarriers, a second subcarrier allocation 322 may include a number of RUs each including 52 subcarriers, a third subcarrier allocation 323 may include a number of RUs each including 106 subcarriers, a fourth subcarrier allocation 324 may include a number of RUs each including 242 subcarriers, a fifth subcarrier allocation 325 may include a number of RUs each including 484 subcarriers, and a sixth subcarrier allocation 326 may include one RU including 996 subcarriers. For each of the example subcarrier allocations 321-326 depicted in FIG. 3C, adjacent RUs may be separated by a null subcarrier, for example, to reduce leakage between adjacent RUs.

The IEEE 802.11ax specification may allow an AP to solicit UL data transmissions from one or more associated stations using trigger frames, and may allow the AP to schedule the delivery of queued DL data to one or more associated stations using trigger frames. In this manner, trigger frames may be used to schedule UL transmissions from multiple stations at the same time, and may be used to schedule DL transmissions to multiple stations at the same time. For example, a trigger frame may identify a number of stations for whom an AP has queued DL data, and may allocate different resource units (RUs) to each of the identified stations. In some aspects, the trigger frame may indicate the size and location of the RU(s) allocated to each of the stations identified by the trigger frame. The trigger frame may also solicit UL transmissions from one or more identified stations, for example, by causing the one or more stations to transmit UL data beginning at some time period after receipt of the trigger frame. The one or more identified stations may concurrently transmit UL data using the RUs allocated by the trigger frame. In some aspects, the trigger frame may also indicate the MCS and the transmit power level to be used by each of the stations for transmitting UL data.

Aspects of the present disclosure may reduce undesirable transmission latencies and increase medium utilization (such as compared with conventional wireless networks) by predicting the protocol type of data or predicting (or estimating) the amount of data (or both) that may be transmitted by each of the STAs in the wireless network during one or more subsequent time periods (such as one or more subsequent TXOPs), and then scheduling an allocation of RUs to one or more of the STAs based on the predicted protocol types or the predicted amounts of data transmissions (or both), respectively. For example, time critical data (such as voice and video traffic) may be transmitted as UDP data packets rather than TCP data packets because UDP data packets do not require affirmative ACK messages to be sent from the receiving device. In some implementations, STAs that transmit or receive UDP data packets may be assigned a different priority for allocations of RUs than STAs that transmit or receive TCP data packets. In some aspects, relatively small RUs may be allocated on a relatively frequent basis to STAs that transmit or receive UDP data packets, and relatively large RUs may be allocated on a relatively infrequent basis to STAs that transmit or receive TCP data packets.

As used herein, an “amount” of RUs allocated in a TXOP may refer to the number of RUs allocated in the TXOP, the size of the RUs allocated in the TXOP, or to both the number and the size of the RUs allocated in the TXOP. As such, adjusting (for example, increasing or decreasing) an amount of allocated RUs may include adjusting a number of RUs allocated, adjusting a size of RUs allocated, or adjusting both a number and a size of RUs allocated in a TXOP. Adjusting an RU allocation also may include adjusting a frequency with which RUs are allocated to a given STA (for example, how often a given STA is scheduled for participation in TXOPs).

In addition, or in the alternative, RUs may be allocated to one or more STAs in the wireless network based on an amount of aggregated data units each of the STAs transmitted or received during one or more time periods. In some aspects, a greater amount of RUs may be allocated to STAs that transmit or receive a relatively large amount of aggregated data units (such as A-MPDUs or A-MDSUs) than to STAs that transmit or receive a relatively small amount of aggregated data units. In other aspects, RUs may be allocated more frequently to STAs that transmit or receive a relatively large amount of aggregated data units than to STAs that transmit or receive a relatively small amount of aggregated data units.

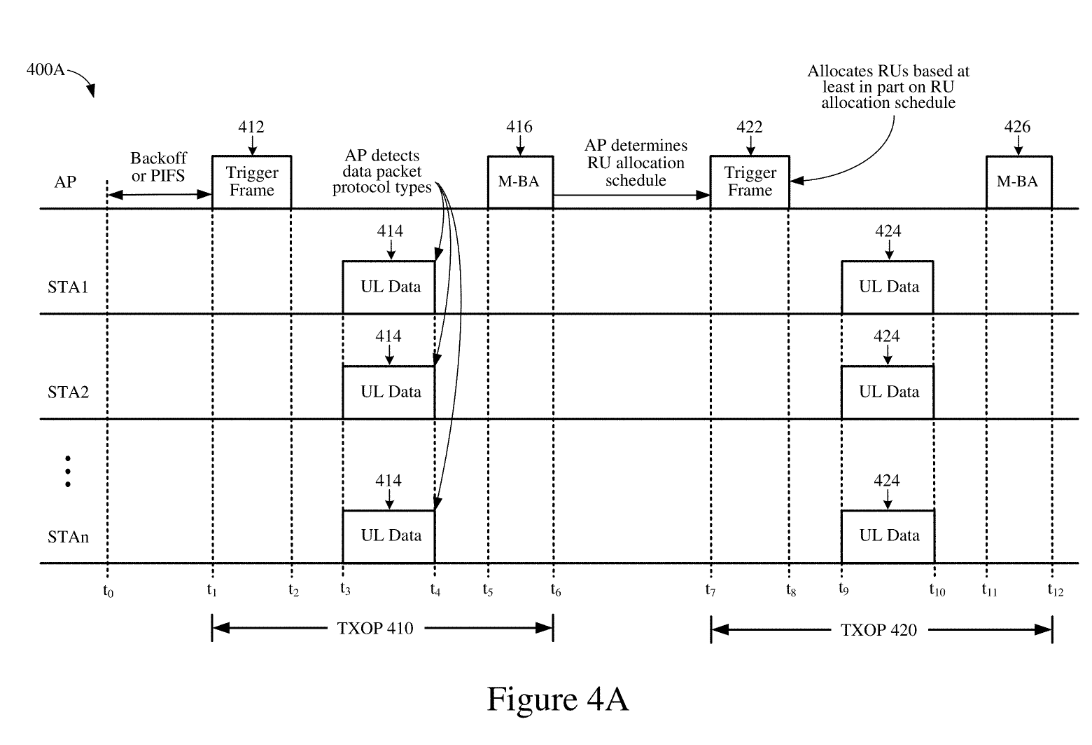

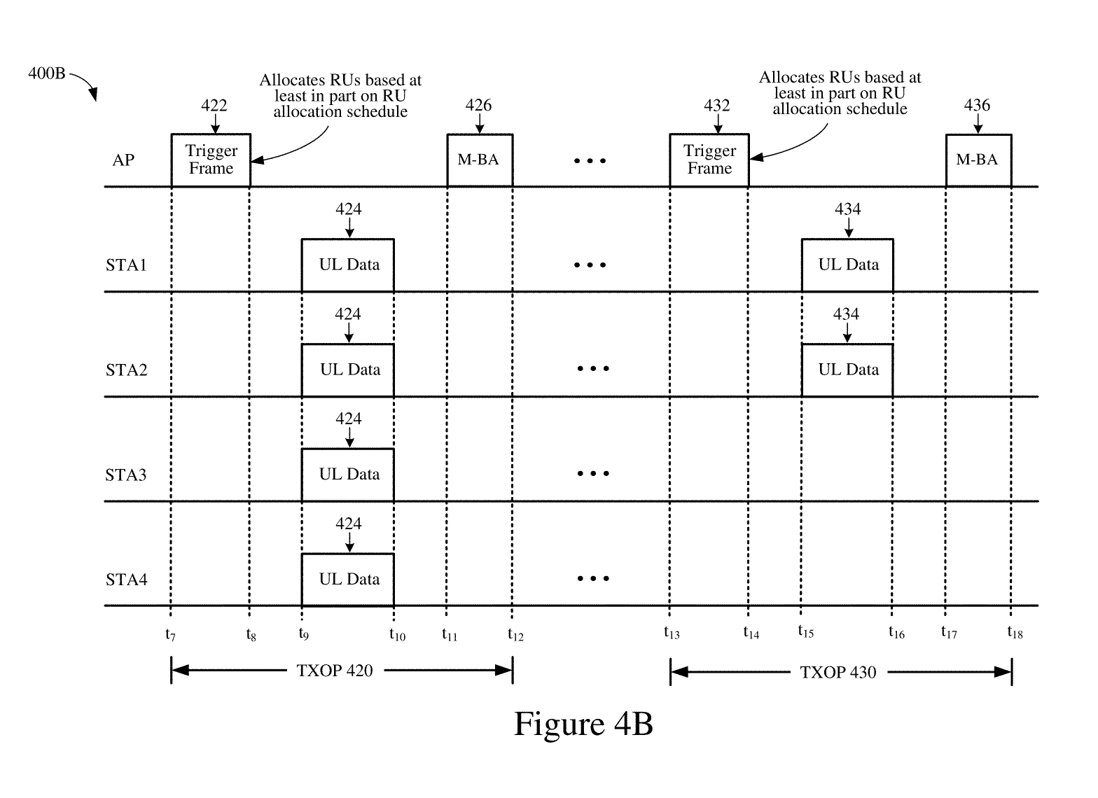

FIG. 4A shows a timing diagram 400 depicting an example operation using trigger frames to allocate resource units (RUs) to one or more wireless stations. The AP of FIG. 4A may be any suitable AP including, for example, the AP 110 of FIG. 1 or the wireless device 200 of FIG. 2. Each of the wireless stations STA1-STAn may be any suitable wireless station including, for example, the stations STA1-STA4 of FIG. 1 or the wireless device 200 of FIG. 2.

In some implementations, the AP may contend for medium access during a backoff period or a point coordination function (PCF) interframe space (PIFS) duration (such as between times t₀ and t₁). In other implementations, the AP may contend for medium access using another suitable channel access mechanism. In some other implementations, the AP may utilize a multiple channel access mechanism, for example, and may not contend for medium access.

The AP gains access to the wireless medium at time t₁, and transmits a first trigger frame 412 to the stations STA1-STAn on a downlink (DL) channel. The stations STA1-STAn receive the first trigger frame 412 at time t₂. The first trigger frame 412 may indicate a beginning of a first transmit opportunity (TXOP) 410. The first trigger frame 412 may allocate one or more RUs to each of the stations STA1-STAn identified by the first trigger frame 412, and may solicit uplink multi-user (UL MU) data transmissions from the identified stations STA1-STAn. For the example of FIG. 4A, all of the stations STA1-STAn are allocated RUs upon which to transmit UL data to the AP. In some aspects, the first trigger frame 412 may schedule UL data transmissions from the identified stations STA1-STAn to commence at an unspecified interframe spacing (xIFS) duration after reception of the first trigger frame 412.

At time t₃, the stations STA1-STAn begin transmitting the scheduled UL MU data 414 using the RUs allocated by the first trigger frame 412. In some aspects, each of the stations STA1-STAn identified by the first trigger frame 412 may determine whether the frequency band associated with its allocated RU has been idle for a duration (such as a PIFS duration) prior to transmitting UL MU data to the AP. The AP may receive the UL data 414 transmitted from the identified stations STA1-STAn at time t₄, and may acknowledge reception of the UL MU data 414 from the stations STA1-STAn by transmitting one or more acknowledgement (ACK) frames to the stations STA1-STAn at time t₅. In some aspects, the AP may acknowledge reception of the UL MU data 414 by transmitting a MU ACK frame to the stations STA1-STAn. In other aspects, the AP may acknowledge reception of the UL MU data 414 by transmitting a multi-station block acknowledgement (M-BA) frame 416 to the stations STA1-STAn, for example, as depicted in the example of FIG. 4A. The stations STA1-STAn may receive the M-BA frame 416 at time t₆.

In some implementations, the AP may determine a type of data packet protocol employed by each of the stations STA1-STAn for transmitting or receiving data packets during the first TXOP 410, for example, by inspecting the data packets transmitted to or received from each of the stations STA1-STAn. For example, the AP may inspect the Internet Protocol field of a respective data packet to determine whether the respective data packet is a UDP data packet or a TCP data packet. The AP may schedule the allocation of RUs to one or more of the stations STA1-STAn for a second TXOP 420 based at least in part on the determined types of data packet protocols employed by the stations STA1-STAn during the first TXOP 410. In some aspects, the AP may identify a first number of the stations STA1-STAn that employ a user datagram protocol (UDP) for transmitting or receiving data packets, and may identify a second number of the stations STA1-STAn that employ a transmission control protocol (TCP) for transmitting or receiving data packets. The AP may determine an RU allocation schedule that allocates RUs of smaller sizes on a more frequent basis to STAs that transmit or receive UDP data packets than to STAs that transmit or receive TCP data packets. For example, the AP may allocate relatively small RUs on a relatively frequent basis to the STAs that transmit or receive UDP data packets, and may allocate relatively large RUs on a relatively infrequent basis to the STAs that transmit or receive TCP data packets. In this manner, the AP may ensure that a sufficient amount of wireless network resources is available to accommodate UDP data transmissions, for example, so that time critical applications associated with UDP data transmissions do not incur undesirable latencies resulting from an unavailability of RUs upon which to transmit UDP data packets.

In addition, or in the alternative, the AP may determine an amount of data associated with the UDP data packets, and may also base the allocation of RUs to the one or more STAs on the amount of data associated with the UDP data packets.

In other implementations, the AP may determine an amount of aggregated data units (such as A-MPDUs and A-MSDUs) exchanged with each of the stations STA1-STAn during the first TXOP 410, and may allocate RUs to one or more of the STAs for the second TXOP 420 based at least in part on the determined amounts of aggregated data units. In some aspects, the AP may compare, for each of the stations STA1-STAn, the amount of aggregated data units with a reference amount. If the determined amount is greater than the reference amount, the AP may define the determined amount to be a relatively large amount. Conversely, if the determined amount is not greater than the reference amount, the AP may define the determined amount to be a relatively small amount. In some aspects, the AP may determine an RU allocation schedule that allocates a greater amount of RUs to a respective STA that transmits or receives a relatively large amount of aggregated data packets than to a respective STA that transmits or receives a relatively small amount of aggregated data packets. In other aspects, the AP may determine an RU allocation schedule that allocates RUs more frequently to STAs that transmit or receive a relatively large amount of aggregated data packets than to STAs that transmit or receive a relatively small amount of aggregated data packets. In this manner, the AP may not only reduce overhead by encouraging the use of aggregated data units but may also ensure that enough bandwidth of the wireless network is (and will be) allocated for the transmission of aggregated data units.

After expiration of the first TXOP 410, the AP gains access to the wireless medium and transmits a second trigger frame 422 to the stations STA1-STAn on the DL channel at time t₇. The stations STA1-STAn receive the second trigger frame 422 at time t₈. The second trigger frame 422 may indicate the beginning of the second TXOP 420. The second trigger frame 422 may allocate RUs to one or more of the stations STA1-STAn for the second TXOP 420 based on the RU allocation schedule determined after the first TXOP 410. Thus, in some implementations, the number and size of the RUs allocated by the second trigger frame 422 may be based on the types of data packet protocols employed by the stations STA1-STAn during the first TXOP 410, may be based on the determined amounts of aggregated data units transmitted or received by the stations STA1-STAn during the first TXOP 410, or both.

At time t₉, the stations STA1-STAn begin transmitting the scheduled UL MU data 424 using the RUs allocated by the second trigger frame 422. The AP may receive the UL MU data 424 transmitted from the stations STA1-STAn at time t₁₀), and may acknowledge reception of the UL MU data 424 transmitted from the stations STA1-STAn by transmitting one or more ACK frames (such as M-BA frame 426) to the stations STA1-STAn at time t₁₁. The stations STA1-STAn may receive the M-BA frame 426 at time t12.

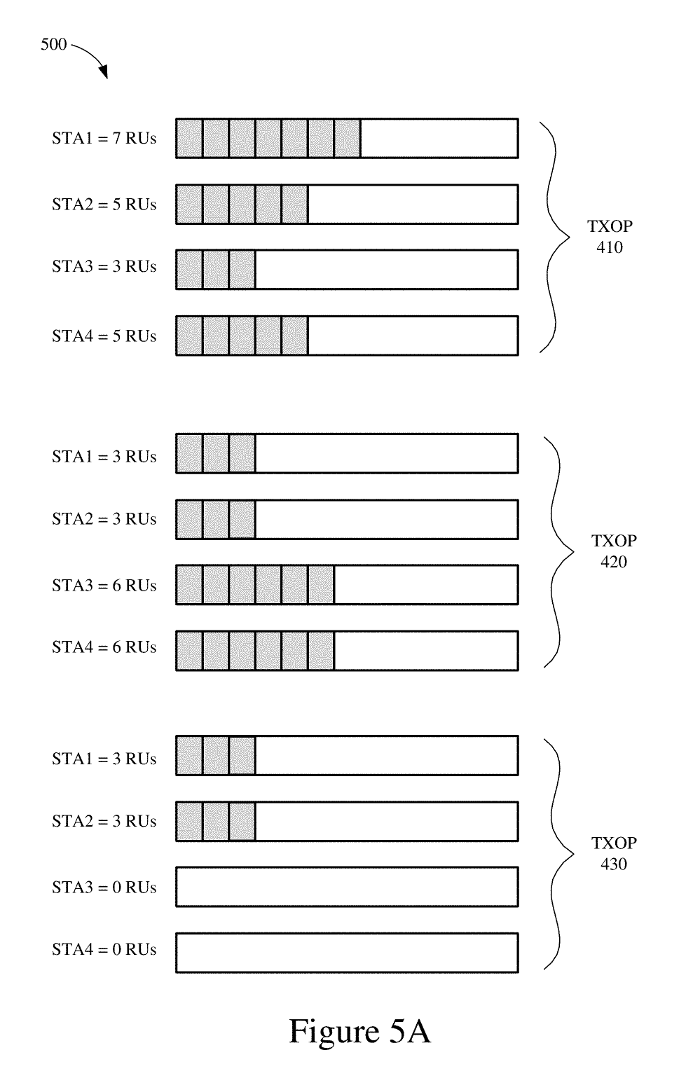

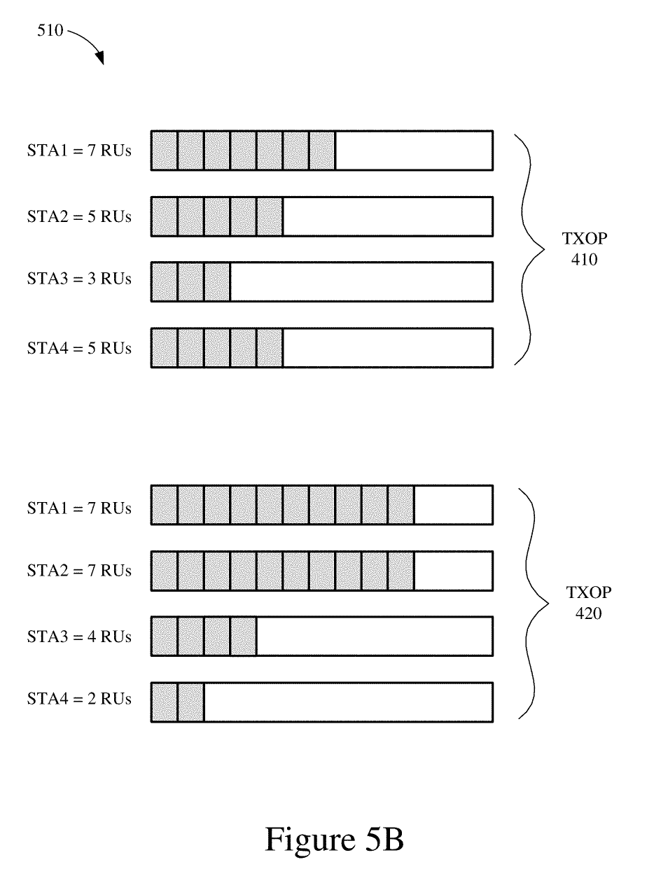

FIG. 5A shows an illustration 500 depicting an example allocation of resource units to four of the stations STA1-STA4 of FIG. 4A based on determined types of data packet protocols. During the first TXOP 410, the AP may not have yet determined a type of data packet protocol employed by some or all of the stations STA1-STAn, for example, because the first TXOP 410 may correspond to an initial exchange of data with one or more of the stations STA1-STAn in the wireless network. In this case, the AP may initially allocate a number of RUs to one or more of the stations STA1-STAn using other criteria. In instances in which the AP has previously facilitated the exchange of data to or from one or more of the stations STA1-STAn, the AP may allocate RUs to these stations based on the types of data packet protocols predicted or otherwise determined to be employed by the respective stations for the first TXOP 410. In the example illustrated in FIG. 5A, the first trigger frame 412 allocates 7 RUs to STA1, allocates 5 RUs to STA2, allocates 3 RUs to STA3, and allocates 5 RUs to STA4 during the first TXOP 410. When the AP receives the UL MU data 414 from the stations STA1-STAn at time t₄, the AP may inspect the data packets to determine a type of data packet protocol employed by each of the stations STA1-STAn.

The stations STA1 and STA2 in the example of FIG. 5A employ a user datagram protocol (UDP) to transmit and receive data packets, and the stations STA3 and STA4 in the example of FIG. 5A employ a transmission control protocol (TCP) to transmit and receive data packets. After receiving the UL MU data 414 in the first TXOP 410 (for example, during any portion of the time period between times t₄ and t₇), the AP may schedule an allocation of RUs for the subsequent second TXOP 420 to the stations STA1-STA4 based on the determined types of data packet protocols used by the respective stations for the UL data in the first TXOP 410. The AP may then indicate the determined allocation schedule for the second TXOP 420 via the second trigger frame 422. Because UDP data transmissions tend to be time critical and TCP data transmissions tend to be non-time critical, the AP may allocate RUs of smaller sizes on a more frequent basis to stations STA1-STA2 than to stations STA3-STA4. For the example of FIG. 5A, the AP allocates 3 RUs to STA1, allocates 3 RUs to STA2, allocates 6 RUs to STA3, and allocates 6 RUs to STA4 during the second TXOP 420, and allocates 3 RUs to STA1, allocates 3 RUs to STA2, allocates no RUs to STA3, and allocates no RUs to STA4 during a third TXOP 430. In this manner, the AP may inspect data packets received from the stations STA1-STAn during the first TXOP 410 to determine a type of data packet protocol used by each of the stations STA1-STAn, and may schedule an allocation of RUs to one or more of the stations STA1-STAn during the second TXOP 420 and the third TXOP 430 (or during any suitable number of subsequent TXOPs) based on the determined types of data packet protocols.

FIG. 4B shows a timing diagram 400B depicting another example operation using trigger frames to allocate resource units (RUs) to one or more wireless stations. The timing diagram 400B of FIG. 4B may correspond to the allocation of RUs to the stations STA1-STA4 of FIG. 5A during the second TXOP 420 and the third TXOP 430. For example, the second trigger frame 422 transmitted by the AP at time t₇ may allocate 3 RUs to STA1, may allocate 3 RUs to STA2, may allocate 6 RUs to STA3, and may allocate 6 RUs to STA4 during the second TXOP 420. The stations STA1-STA4 transmit UL MU data 424 on their allocated RUs between times t₉ and t₁₀, and the AP acknowledges reception of the UL MU data 424 by transmitting an M-BA frame 426 at time t₁₁. Thereafter, the AP may transmit a third trigger frame 432 to the stations STA1-STA4 at time t₁₃. The third trigger frame 432 may allocate 3 RUs to STA1, may allocate 3 RUs to STA2, may allocate no RUs to STA3, and may allocate no RUs to STA4 during the third TXOP 430. The stations STA1-STA2 transmit UL MU data 434 on their allocated RUs between times t₁₅ and t₁₆, and the stations STA3-STA4 do not transmit any UL data during the third TXOP 430. The AP acknowledges reception of the UL MU data 434 from stations STA1-STA2 by transmitting an M-BA frame 436 at time t₁₇.

As described above with respect to FIGS. 4A-4B and FIG. 5A, the AP allocates smaller RUs on a more frequent basis to the stations STA1-STA2 which transmit or receive UDP data packets than to the stations STA3-STA4 which transmit or receive TCP data packets, for example, by not allocating any RUs to the stations STA3-STA4 during the third TXOP 430 via the third trigger frame 432. In this manner, the AP may ensure that a sufficient amount of wireless network resources is available to accommodate UDP data transmissions by increasing the frequency with which RUs are allocated to STAs that transmit or receive UDP data packets (as compared to STAs that transmit or receive TCP data packets), and may ensure fair access to the wireless medium by allocating smaller RUs to STAs that transmit or receive UDP data packets than to STAs that transmit or receive TCP data packets. In addition, or in the alternative, the AP may allocate RUs more frequently to STAs that transmit or receive UDP data packets than to STAs that transmit or receive TCP data packets by adjusting the frequency with which trigger frames are transmitted to the STAs.

FIG. 5B shows an illustration 510 depicting an example allocation of resource units to the stations STA1-STAn of FIG. 4A based on determined amounts of aggregated data units transmitted by the stations STA1-STAn. Again, during the first TXOP 410, the AP may not have yet determined whether some or all of the stations STA1-STAn transmitted or received aggregated data units, for example, because the first TXOP 410 may correspond to an initial exchange of data with one or more of the stations STA1-STAn in the wireless network. In this case, the AP may initially allocate a number of RUs to one or more of the stations STA1-STAn using other criteria. In instances in which the AP has previously facilitated the exchange of data to or from one or more of the stations STA1-STAn, the AP may allocate RUs to these stations STA1-STAn based on amounts of aggregated data units estimated or otherwise determined to be used by the respective stations for the first TXOP 410. As depicted in FIG. 5B, the first trigger frame 412 allocates 7 RUs to STA1, allocates 5 RUs to STA2, allocates 3 RUs to STA3, and allocates 5 RUs to STA4 during the first TXOP 410.

Referring also to FIG. 4A, as the AP receives the UL MU data 414 from the stations STA1-STAn at time t₄, the AP may detect whether any of the stations STA1-STAn are transmitting aggregated data units, and if so, may determine the numbers, sizes or amounts of aggregated data units transmitted by each of the stations STA1-STAn during the first TXOP 410. In some other implementations, the AP may determine the numbers, sizes or amounts of aggregated data units transmitted from or received by each of the stations STA1-STAn during other time periods, for example, during the TXOP 410 and one or more previous TXOPs.

The stations STA1 and STA2 of the example of FIG. 5B may be determined to transmit or receive a relatively large amount of aggregated data units, and the stations STA3 and STA4 of the example of FIG. 5B may be determined to transmit or receive a relatively small amount of aggregated data units. After receiving the UL MU data 414 in the first TXOP 410, for example, during any portion of the time period between times t₄ and t₇, the AP may schedule an allocation of RUs for the subsequent second TXOP 420 to the stations STA1-STA4 based on the determined amounts of transmitted or received aggregated data units during the first TXOP 410.

The AP may then indicate the determined allocation schedule for the second TXOP 420 via the second trigger frame 422. Because aggregating data for transmission may reduce overhead, it is desirable to ensure that sufficient resources of the wireless network are available for the transmission of aggregated data units (such as A-MPDUs and A-MSDUs), for example, by allocating a greater amount of RUs to stations STA1-STA2 than to stations STA3-STA4. The AP may determine that stations STA1 and STA2 transmit the largest amounts of aggregated data units, followed by station STA3, and followed by station STA4. Thus, as shown in the example of FIG. 5B, the AP allocates 7 RUs to STA1, allocates 7 RUs to STA2, allocates 4 RUs to STA3, and allocates 2 RUs to STA4 during the second TXOP 420. In this manner, the AP may reserve sufficient resources of the wireless network to ensure that each of the stations STA1-STA4 are able to transmit aggregated data units during the second TXOP 420.

FIG. 6A shows an illustrative flow chart depicting an example operation 600 for allocating wireless medium resources to wireless devices. The operation 600 may be performed by the wireless device 200 of FIG. 2. In some implementations, the operation 600 may be performed by the processor 220 executing any feasible software or instructions stored in the memory 230 of the wireless device 200. In other implementations, the operation 600 may be performed by hardware modules, firmware modules, or any feasible combination of hardware, firmware, and software modules included within the wireless device 200. In some aspects, the wireless device 200 may operate as an AP, and may perform the operation 600 to allocate wireless medium resources to a plurality of stations (STAs) in a wireless network.

The wireless device 200 may determine a type of data packet protocol employed by each of the plurality of STAs for transmitting or receiving data packets (602). FIG. 6B shows an illustrative flow chart depicting an example operation 602′ for determining a type of data packet protocol employed by each of a plurality of STAs. In some implementations, the wireless device 200 may inspect data packets transmitted to or received from each of the STAs and determine the type of data packet protocol used to transmit the data packets (602A). For example, the inspected data packets may be obtained in a current or previous TXOP. In some aspects, the wireless device 200 may identify a first number of the STAs that employ a user datagram protocol (UDP) for transmitting or receiving data packets (602B) based on the inspected data packets, and may identify a second number of the STAs that employ a transmission control protocol (TCP) for transmitting or receiving data packets (602C) based on the inspected data packets.

The wireless device 200 may allocate a number of resource units (RUs) to one or more of the STAs based at least in part on the determined types of data packet protocols (604). For example, the allocation of RUs may be for a next TXOP (or for one or more subsequent TXOPs). FIG. 6C shows an illustrative flow chart depicting an example operation 604′ for allocating a number of RUs to one or more STAs. In some implementations, the wireless device 200 may allocate relatively small RUs on a relatively frequent basis to STAs that employ a UDP for transmitting or receiving data packets (604A), and may allocate relatively large RUs on a relatively infrequent basis to STAs that employ a TCP for transmitting or receiving data packets (604B). In some implementations, the wireless device 200 may assign a higher priority to UDP data packets than to TCP data packets to ensure that enough bandwidth of the wireless network is reserved to accommodate UDP data packet transmissions. As discussed above, UDP data packets may be associated with time critical applications having relatively low error tolerances (such as voice and video transmissions), while TCP data packets may be associated with non-time critical applications having relatively high error tolerances (such as data back-up operations). Thus, the wireless device 200 may increase the frequency with which RUs are allocated to STAs that transmit or receive UDP data packets (as compared to STAs that transmit or receive TCP data packets) to ensure that a sufficient amount of wireless network resources are available to accommodate UDP data transmissions. In this manner, time critical applications associated with UDP data transmissions may not incur undesirable latencies resulting from an unavailability of RUs upon which to transmit UDP data packets. The wireless device 200 may ensure fair access to the wireless medium by allocating smaller RUs to STAs that transmit or receive UDP data packets than to STAs that transmit or receive TCP data packets. The frequency of the RU allocations (and in some cases the frequency with which the trigger frames are transmitted) may be based on previous UDP data packets, including, for example, when the previous UDP data packets were transmitted or received, and the sizes of the previous UDP data packets.

In some implementations of the allocation operation 604′, the wireless device 200 may allocate at least one RU to each of the STAs that employs a UDP for transmitting or receiving data packets. In this manner, the wireless device 200 may guarantee a minimum amount of channel access to each of the STAs that employs a UDP for transmitting or receiving data packets. Any remaining RUs (such as the RUs remaining after at least one RU is allocated to each of the STAs associated with UDP data packets) may be distributed to the STAs in any suitable manner.

In some implementations of the allocation operation 604′, the wireless device 200 may determine an amount of data associated with the UDP data packets, and may also base the allocation of RUs to the one or more STAs on the amount of data associated with the UDP data packets.

In some implementations of the allocation operation 604′, the wireless device 200 may determine a level of traffic on the wireless network, and may adjust the allocation of RUs to the one or more STAs based at least in part on the determined level of traffic. The level of traffic, which may indicate a level of congestion on the wireless network, may increase when the number of users (STAs) exceeds a value, may increase when the amount of wireless traffic exceeds an amount, or both. In some aspects, the wireless device 200 may alleviate network congestion by allocating RUs to the STAs more frequently (such as rather than allocating more RUs or larger RUs in a given trigger frame) by increasing the number of trigger frames transmitted during a time period. In this manner, the wireless device 200 may allocate RUs to the STAs more frequently when a high traffic condition exists, and may allocate RUs to the STAs less frequently when the high traffic condition does not exist.

In some implementations of the allocation operation 604′, the wireless device 200 may determine an amount of aggregated data units exchanged with each of the STAs, and may adjust the allocation of RUs to the one or more STAs based at least in part on the determined amounts. Because aggregated data units (such as A-MPDUs and A-MSDUs) may reduce overhead, it may be desirable to ensure that enough bandwidth of the wireless network is available to accommodate the transmission of aggregated data units. In some aspects, the wireless device 200 may increase the number of RUs allocated to STAs that exchange a relatively large amount of aggregated data units (such as greater than a reference amount), and decrease the number of RUs allocated to STAs that exchange a relatively small amount of aggregated data units (such as not greater than the reference amount).

The wireless device 200 may transmit a trigger frame indicating the allocation of the number of RUs to the one or more STAs (606). The trigger frame may identify each of the one or more STAs that have been allocated RUs, and may identify the size and location of the RU(s) allocated to each of the one or more STAs. In some aspects, the trigger frame may also indicate the MCS and power level to be used by each of the identified STAs when transmitting UL data to the wireless device 200.

FIG. 7A shows an illustrative flow chart depicting another example operation 700 for allocating wireless medium resources to wireless devices. The operation 700 may be performed by the wireless device 200 of FIG. 2. In some implementations, the operation 700 may be performed by the processor 220 executing any feasible software or instructions stored in the memory 230 of the wireless device 200. In other implementations, the operation 700 may be performed by hardware modules, firmware modules, or any feasible combination of hardware, firmware, and software modules included within the wireless device 200. In some aspects, the wireless device 200 may operate as an AP, and may perform the operation 700 to allocate wireless medium resources to a plurality of stations (STAs) in a wireless network.

The wireless device 200 may determine an amount of aggregated data units exchanged with each of the plurality of STAs (702). In some implementations, the wireless device 200 may compare, for each of the STAs, the amount of aggregated data units with a reference amount. If the determined amount is greater than the reference amount, the wireless device 200 may define the determined amount to be a relatively large amount. Conversely, if the determined amount is not greater than the reference amount, the wireless device 200 may define the determined amount to be a relatively small amount.

The wireless device 200 may allocate a number of resource units (RUs) to one or more of the STAs based at least in part on the determined amounts of aggregated data units (704). FIG. 7B shows an illustrative flow chart depicting an example operation 704′ for allocating a number of RUs to one or more STAs. In some implementations, the wireless device 200 may allocate more RUs to STAs which transmit relatively large amounts of aggregated data units, and may allocate less RUs to STAs which transmit relatively small amounts of aggregated data units (704A). In other implementations, the wireless device 200 may adjust the number of RUs allocated to a respective STA based on the amount of aggregated data units transmitted or received by the respective STA (704B).

The wireless device 200 may transmit a trigger frame indicating the allocation of the number of RUs to the one or more STAs (706). The trigger frame may identify each of the one or more STAs that have been allocated RUs, and may identify the size and location of the RU(s) allocated to each of the one or more STAs. In some aspects, the trigger frame may also indicate the MCS and power level to be used by each of the identified STAs when transmitting UL data (such to the wireless device 200).

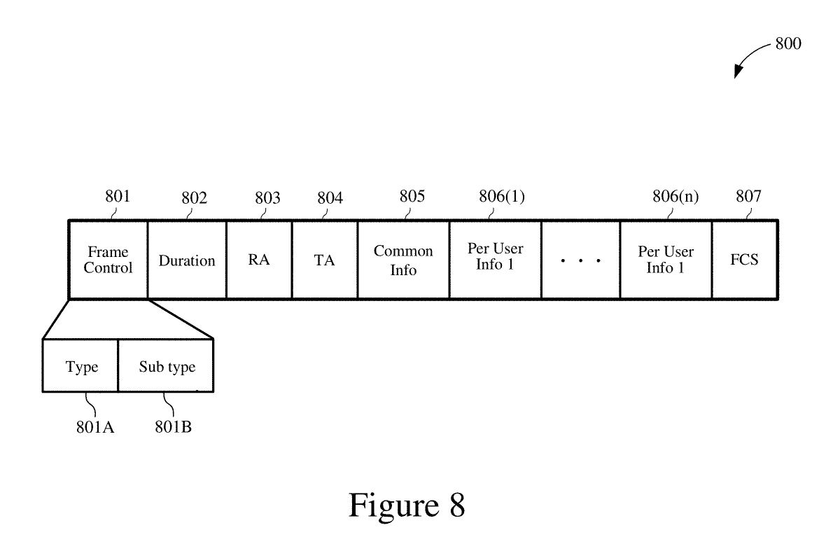

FIG. 8 shows an example trigger frame 800. The trigger frame 800 may be used as the trigger frames 412 and 422 of FIG. 4. The trigger frame 800 is shown to include a frame control field 801, a duration field 802, a receiver address (RA) field 803, a transmitter address (TA) field 804, a Common Info field 805, a number of Per User Info fields 806(1)-806(n), and a frame check sequence (FCS) field 807.

The frame control field 801 includes a Type field 801A and a Sub-type field 801B. The Type field 801A may store a value to indicate that the trigger frame 800 is a control frame, and the Sub-type field 801B may store a value indicating a type of the trigger frame 800. The duration field 802 may store information indicating a duration or length of the trigger frame 800. The RA field 803 may store the address of a receiving device (such as one of the wireless stations STA1-STAn of FIG. 4). The TA field 804 may store the address of a transmitting device (such as the AP of FIG. 4). The Common Info field 805 may store information common to one or more receiving devices (such as one of the wireless stations STA1-STAn of FIG. 4). Each of the Per User Info fields 806(1)-806(n) may store information for a particular receiving device including, for example, the AID of the receiving device. The FCS field 807 may store a frame check sequence (such as for error detection).

In some aspects, the trigger frame 800 may allocate dedicated RUs to associated STAs identified by AID values stored in corresponding ones of the Per User Info fields 806(1)-806(n). In other aspects, the trigger frame 800 may allocate random RUs to one or more groups of STAs using pre-defined AID values stored in the Per User Info fields 806(1)-806(n).

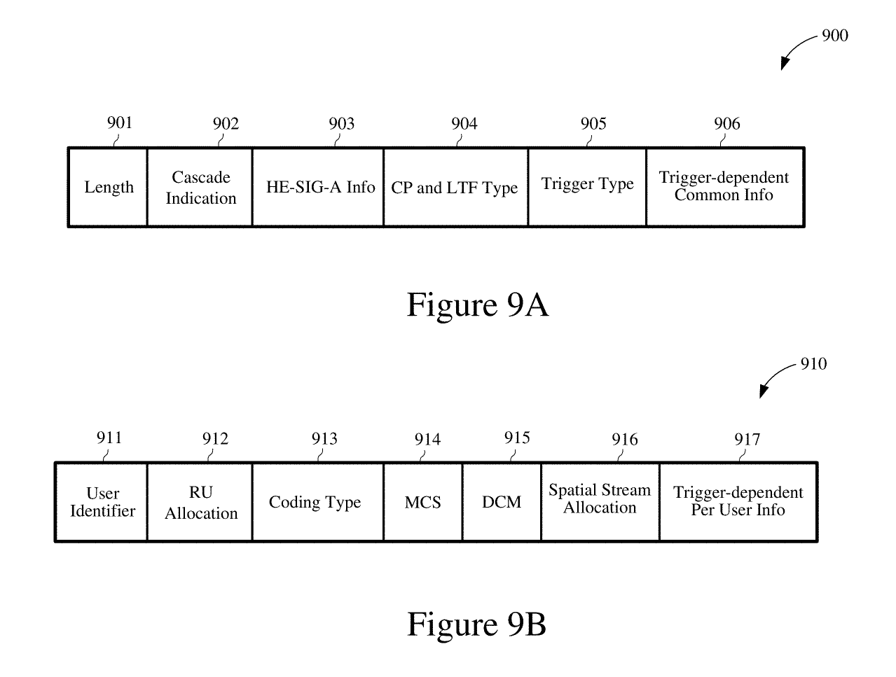

FIG. 9A shows an example Common Info field 900. The Common Info field 900 may be one implementation of the Common Info field 805 of the trigger frame 800 of FIG. 8. The Common Info field 900 is shown to include a length subfield 901, a cascade indication subfield 902, a high-efficiency signaling A (HE-SIG-A) info subfield 903, a cyclic prefix (CP) and legacy training field (LTF) type subfield 904, a trigger type subfield 905, and a trigger-dependent common info subfield 906. The length subfield 901 may indicate the length of a legacy signaling field of the UL data frames to be transmitted in response to the trigger frame 800. The cascade indication subfield 902 may indicate whether a subsequent trigger frame follows the current trigger frame. The HE-SIG-A Info subfield 903 may indicate the contents of a HE-SIG-A field of the UL data frames to be transmitted in response to the trigger frame 800. The CP and LTF type subfield 904 may indicate the cyclic prefix and HE-LTF type of the UL data frames to be transmitted in response to the trigger frame 800. The trigger type subfield 905 may indicate the type of trigger frame. The trigger-dependent common info subfield 906 may indicate trigger-dependent information.

FIG. 9B shows an example Per User Info field 910. The Per User Info field 910 may be one implementation of the Per User Info fields 806(1)-806(n) of the trigger frame 800. The Per User Info field 910 is shown to include a User Identifier subfield 911, an RU Allocation subfield 912, a Coding Type subfield 913, an MCS subfield 914, a dual-carrier modulation (DCM) subfield 915, a spatial stream (SS) Allocation subfield 916, and a trigger-dependent Per User info subfield 917. The User Identifier subfield 911 may indicate the association identification (AID) of the STA to which a dedicated RU is allocated for transmitting UL MU data. The RU Allocation subfield 912 may identify the dedicated RU allocated to the corresponding STA (such as the STA identified by the User Identifier subfield 911). The Coding Type subfield 913 may indicate the type of coding to be used by the corresponding STA when transmitting UL data using the allocated RU. The MCS subfield 914 may indicate the MCS to be used by the corresponding STA when transmitting UL data using the allocated RU. The DCM subfield 915 may indicate the dual carrier modulation to be used by the corresponding STA when transmitting UL data using the allocated RU. The SS Allocation subfield 916 may indicate the number of spatial streams to be used by the corresponding STA when transmitting UL data using the allocated RU.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single-chip or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, or, any conventional processor, controller, microcontroller, or state machine. A processor also may be implemented as a combination of computing devices, e.g., a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein.

What is claimed is:

1. A method of allocating wireless medium resources to a plurality of stations (STAs) in a wireless network, comprising:
determining a type of data packet protocol employed by each of the plurality of STAs for transmitting or receiving data packets;
allocating a number of resource units (RUs) to one or more of the STAs based at least in part on the determined types of data packet protocols; and
transmitting a trigger frame indicating the allocation of the number of RUs to the one or more STAs.

2. The method of claim 1, wherein determining the types of data packet protocols comprises:
identifying a first number of the STAs that employ a user datagram protocol (UDP) for transmitting or receiving data packets; and
identifying a second number of the STAs that employ a transmission control protocol (TCP) for transmitting or receiving data packets.

3. The method of claim 2, wherein at least one of the RUs is allocated to each of the first number of STAs.

4. The method of claim 2, wherein the number of RUs are allocated only to the first number of STAs.

5. The method of claim 2, wherein the allocating comprises:
allocating relatively small RUs on a relatively frequent basis to the first number of STAs; and
allocating relatively large RUs on a relatively infrequent basis to the second number of STAs.

6. The method of claim 1, wherein the allocating comprises:
allocating smaller RUs more frequently to STAs that employ a user datagram protocol (UDP) for transmitting or receiving data packets than to STAs that employ a transmission control protocol (TCP) for transmitting or receiving data packets.

7. The method of claim 1, further comprising:
determining a level of traffic on the wireless network; and
adjusting the allocation of RUs to the one or more STAs based at least in part on the level of traffic.

8. The method of claim 1, further comprising:
determining an amount of aggregated data units exchanged with each of the plurality of STAs; and
adjusting the allocation of RUs to the one or more STAs based at least in part on the determined amounts.

9. The method of claim 8, wherein the aggregated data units are selected from the group consisting of aggregated medium access control protocol data units (A-MPDUs) and aggregated medium access control service data units (A-MSDUs).

10. A wireless device, comprising:
one or more processors; and
a memory configured to store instructions that, when executed by the one or more processors, cause the wireless device to:
determine a type of data packet protocol employed by each of the plurality of STAs for transmitting or receiving data packets;
allocate a number of resource units (RUs) to one or more of the STAs based at least in part on the determined types of data packet protocols; and
transmit a trigger frame indicating the allocation of the number of RUs to the one or more STAs.

11. The wireless device of claim 10, wherein execution of the instructions to determine the types of data packet protocols causes the wireless device to further:
identify a first number of the STAs that employ a user datagram protocol (UDP) for transmitting or receiving data packets; and
identify a second number of the STAs that employ a transmission control protocol (TCP) for transmitting or receiving data packets.

12. The wireless device of claim 11, wherein at least one of the RUs is allocated to each of the first number of STAs.

13. The wireless device of claim 11, wherein the number of RUs are allocated only to the first number of STAs.

14. The wireless device of claim 11, wherein execution of the instructions to allocate causes the wireless device to:
allocate relatively small RUs on a relatively frequent basis to the first number of STAs; and
allocate relatively large RUs on a relatively infrequent basis to the second number of STAs.

15. The wireless device of claim 10, wherein execution of the instructions to allocate causes the wireless device to:
allocate smaller RUs more frequently to STAs that employ a user datagram protocol (UDP) for transmitting or receiving data packets than to STAs that employ a transmission control protocol (TCP) for transmitting or receiving data packets.

16. The wireless device of claim 10, wherein execution of the instructions causes the wireless device to further:
determine a level of traffic on the wireless network; and
adjust the allocation of RUs to the one or more STAs based at least in part on the determined level of traffic.

17. The wireless device of claim 10, wherein execution of the instructions causes the wireless device to further:
determine an amount of aggregated data units exchanged with each of the STAs; and
adjust the allocation of RUs to the one or more STAs based at least in part on the determined amounts.

18. The wireless device of claim 17, wherein the aggregated data units are selected from the group consisting of aggregated medium access control protocol data units (A-MPDUs) and aggregated medium access control service data units (A-MSDUs).

19. A non-transitory computer-readable storage medium comprising instructions that, when executed by one or more processors of a wireless device, cause the wireless device to perform operations comprising:
determining a type of data packet protocol employed by each of a plurality of stations (STAs) for transmitting or receiving data packets;
allocating a number of resource units (RUs) to one or more of the STAs based at least in part on the determined types of data packet protocols; and
transmitting a trigger frame indicating the allocation of the number of RUs to the one or more STAs.

20. The non-transitory computer-readable storage medium of claim 19, wherein execution of the instructions for determining the types of data packet protocols causes the wireless device to perform operations further comprising:
identifying a first number of the STAs that employ a user datagram protocol (UDP) for transmitting or receiving data packets; and
identifying a second number of the STAs that employ a transmission control protocol (TCP) for transmitting or receiving data packets.

21. The non-transitory computer-readable storage medium of claim 20, wherein at least one of the RUs is allocated to each of the first number of STAs.

22. The non-transitory computer-readable storage medium of claim 20, wherein the number of RUs are allocated only to the first number of STAs.

23. The non-transitory computer-readable storage medium of claim 20, wherein execution of the instructions to allocate causes the wireless device to perform operations further comprising:
allocating relatively small RUs on a relatively frequent basis to the first number of STAs; and
allocating relatively large RUs on a relatively infrequent basis to the second number of STAs.

24. The non-transitory computer-readable storage medium of claim 19, wherein execution of the instructions to allocate causes the wireless device to perform operations further comprising:
allocating smaller RUs more frequently to STAs that employ a user datagram protocol (UDP) for transmitting or receiving data packets than to STAs that employ a transmission control protocol (TCP) for transmitting or receiving data packets.

25. The non-transitory computer-readable storage medium of claim 19, wherein execution of the instructions causes the wireless device to perform operations further comprising:
determining a level of traffic on the wireless network; and
adjusting the allocation of RUs to the one or more STAs based at least in part on the determined level of traffic.

26. The non-transitory computer-readable storage medium of claim 19, wherein execution of the instructions causes the wireless device to perform operations further comprising:
determining an amount of aggregated data units exchanged with each of the STAs; and
adjusting the allocation of RUs to the one or more STAs based at least in part on the determined amounts.

27. A wireless device comprising:
means for determining a type of data packet protocol employed by each of a plurality of stations (STAs) for transmitting or receiving data packets;
means for allocating a number of resource units (RUs) to one or more of the STAs based at least in part on the determined types of data packet protocols; and
means for transmitting a trigger frame indicating the allocation of the number of RUs to the one or more STAs.

28. The wireless device of claim 27, wherein the means for determining the types of data packet protocols further comprises:
means for identifying a first number of the STAs that employ a user datagram protocol (UDP) for transmitting or receiving data packets; and
means for identifying a second number of the STAs that employ a transmission control protocol (TCP) for transmitting or receiving data packets.

29. The wireless device of claim 28, wherein the means for allocating is to:
allocate relatively small RUs on a relatively frequent basis to the first number of STAs; and
allocate relatively large RUs on a relatively infrequent basis to the second number of STAs.

30. The wireless device of claim 27, wherein the means for allocating is to allocate smaller RUs more frequently to STAs that employ a user datagram protocol (UDP) for transmitting or receiving data packets than to STAs that employ a transmission control protocol (TCP) for transmitting or receiving data packets.
